(19) United States
(12) Patent Application Publication
(10) Pub. No.: US 2012/0192110 A1
(43) Pub. Date: Jul. 26, 2012

(54) ELECTRONIC DEVICE AND INFORMATION DISPLAY METHOD THEREOF

(75) Inventor: Yi-Hsi Wu, Taipei City (TW)

(73) Assignee: COMPAL ELECTRONICS, INC., Taipei City (TW)

(21) Appl. No.: 13/077,990

(22) Filed: Apr. 1, 2011

(30) Foreign Application Priority Data
Jan. 25, 2011 (TW) 100102727

(51) Int. Cl. G06F 3/048

(52) U.S. Cl. 715/815

(57) ABSTRACT

An electronic device and an information display method thereof are provided. The electronic device has a screen and is configured to receive signals from a touch input/output interface. The screen displays a file management frame including a plurality of objects, wherein each of the objects is corresponding to a view area within the file management frame and has additional information and/or a preview icon. In the present method, an enlargement or shrinking touch signal is detected via the touch input/output interface. The view area corresponding to each of the objects is adjusted according to the enlargement or shrinking touch signal. Regarding each of the objects, the content of the additional information to be displayed in the view area corresponding to the object is changed according to the enlargement or shrinking touch signal.

### CROSS-REFERENCE TO RELATED APPLICATION

This application claims the priority benefit of Taiwan application serial no. 100102727, filed Jan. 25, 2011. The entirety of the above-mentioned patent application is hereby incorporated by reference herein and made a part of this specification.

### BACKGROUND OF THE INVENTION

1. Field of the Invention

The invention generally relates to an operation method of an electronic device, and more particularly, to a method for displaying information in response to an operation gesture on a touch interface and an electronic device using the same.

2. Description of Related Art

Along with the advancement of technologies and the widespread of computers, using computers has become one of the most indispensable parts of modern lifestyle. Nowadays, people use computer systems for office work, communication, browsing information, and entertainment.

Most existing computer systems adopt Windows operating systems. Thus, a user can view files and folders in a computer system in different mode, such as thumbnails, icons, list, or details. Generally speaking, in a computer system, folders are represented with a specific icon, and different types of files are represented with different types of predetermined icons. Accordingly, a user can instantly know the type of a file through the icon of the file. In addition, when files and folders are displayed as thumbnails, a user can instantly understand the original content of each image file through the thumbnails of the image files, so that the user can easily select the desired image files among a large number of image files.

However, in an existing Windows operating system, even though the thumbnail of a file or folder can be enlarged, the user can only obtain the title of the file or folder and the image of the thumbnail itself. Along with the diversification of data stored in computer systems, how to allow a user to obtain more information in a convenient manner has become one of the major subjects in the industry.

### SUMMARY OF THE INVENTION

Accordingly, the invention is directed to an information display method which allows a user to obtain information of objects (files, shortcuts, and folders) in an electronic device conveniently.

The invention is directed to an electronic device which provides a convenient method for a user to obtain information of objects (files, shortcuts, and folders) in an electronic device.

The invention provides an information display method adaptable to an electronic device, wherein the electronic device has a screen and is configured to receive signals from a touch input/output interface, the screen displays a file management frame including a plurality of objects, and each of the objects is corresponding to a view area within the file management frame and has additional information and/or a preview icon. In the information display method, an enlargement or shrinking touch signal is detected via the touch input/output interface. The view area corresponding to each of the objects is adjusted according to the enlargement or shrinking touch signal. Regarding each of the objects, a content of the additional information displayed in the view area corresponding to the object is changed according to the enlargement or shrinking touch signal.

According to an embodiment of the invention, in the step of adjusting the view area corresponding to each of the objects according to the enlargement or shrinking touch signal, the view areas corresponding to the objects are simultaneously adjusted according to the enlargement or shrinking touch signal.

According to an embodiment of the invention, in the step of simultaneously adjusting the view areas corresponding to the objects according to the enlargement or shrinking touch signal, the view areas corresponding to the objects are simultaneously enlarged if a distance between a first touch signal and a second touch signal increases, and the view areas corresponding to the objects are simultaneously reduced if the distance between the first touch signal and the second touch signal decreases. In which, the enlargement or shrinking touch signal is composed of the first touch signal and the second touch signal.

According to an embodiment of the invention, in the step of regarding each of the objects, changing the content of the additional information displayed in the view area corresponding to the object according to the enlargement or shrinking touch signal, the content of the additional information is correspondingly changed according to the enlargement or shrinking touch signal, wherein the content includes an amount of the additional information and/or one or a combination of a number, a size, and an arrangement of sub icons of the preview icon.

According to an embodiment of the invention, in the step of correspondingly changing the content of the additional information according to the enlargement or shrinking touch signal, the amount of the additional information is increased in the view area corresponding to the object if a distance between a first touch signal and a second touch signal increases, and the amount of the additional information is decreased in the view area corresponding to the object if the distance between the first touch signal and the second touch signal decreases. In which, the enlargement or shrinking touch signal is composed of the first touch signal and the second touch signal.

According to an embodiment of the invention, the information display method further enlarges the preview icon of the object while increasing the amount of the additional information and reduces the preview icon of the object while decreasing the amount of the additional information.

According to an embodiment of the invention, in the step of correspondingly changing the content of the additional information according to the enlargement or shrinking touch, the number of sub icons of the preview icon is increased in the view area corresponding to the object if a distance between a first touch signal and a second touch signal increases, and the number of sub icons of the preview icon is decreased in the view area corresponding to the object if the distance between the first touch signal and the second touch signal decreases. In which, the enlargement or shrinking touch signal is composed of the first touch signal and the second touch signal.

According to an embodiment of the invention, in the step of correspondingly changing the content of the additional information according to the enlargement or shrinking touch signal, the sub icons of the preview icon are enlarged in the view area corresponding to the object if a distance between a first touch signal and a second touch signal increases, and the sub icons of the preview icon are reduced in the view area corresponding to the object if the distance between the first touch signal and the second touch signal decreases. In which, the enlargement or shrinking touch signal is composed of the first touch signal and the second touch signal.

According to an embodiment of the invention, in the step of correspondingly changing the content of the additional information according to the enlargement or shrinking touch signal, an overlapped extent between the sub icons of the preview icon is decreased in the view area corresponding to the object if a distance between a first touch signal and a second touch signal increases, and the overlapped extent between the sub icons of the preview icon is increased in the view area corresponding to the object if the distance between the first touch signal and the second touch signal decreases. In which, the enlargement or shrinking touch signal is composed of the first touch signal and the second touch signal.

According to an embodiment of the invention, the additional information includes an object creation time and a custom tag.

According to an embodiment of the invention, each of the objects is a file, a shortcut, or a folder, and when the object is a folder, each of the sub icons of the preview icon is corresponding to a sub object in the folder.

According to an embodiment of the invention, the touch input/output interface is a remote control device, a portable electronic device, a touch pad, or a director.

The invention provides an electronic device including a screen, a determination module, and an information display module. The screen displays a file management frame including a plurality of objects, wherein each of the objects is corresponding to a view area within the file management frame and has additional information and/or a preview icon. The determination module receives signals from a touch input/output interface and determines whether an enlargement or shrinking touch signal is detected via the touch input/output interface. The information display module is coupled to the screen and the determination module. The information display module adjusts the view areas corresponding to the objects according to the enlargement or shrinking touch signal, and regarding each of the objects, the information display module changes a content of the additional information to be displayed according to the enlargement or shrinking touch signal and controls the screen to display the additional information and the preview icon in the view area corresponding to the object.

According to an embodiment of the invention, the information display module simultaneously adjusts the view areas corresponding to the objects according to the enlargement or shrinking touch signal.

According to an embodiment of the invention, the information display module simultaneously enlarges the view areas corresponding to the objects when a distance between a first touch signal and a second touch signal increases and simultaneously reduces the view areas corresponding to the objects when the distance between the first touch signal and the second touch signal decreases. In which, the enlargement or shrinking touch signal is composed of the first touch signal and the second touch signal.

According to an embodiment of the invention, regarding each of the objects, the information display module correspondingly changes the content of the additional information according to the enlargement or shrinking touch signal, wherein the content includes an amount of the additional information and/or one or a combination of a number, a size, and an arrangement of sub icons of the preview icon.

According to an embodiment of the invention, the information display module increases the amount of the additional information in the view area corresponding to the object when a distance between a first touch signal and a second touch signal increases and decreases the amount of the additional information in the view area corresponding to the object when the distance between the first touch signal and the second touch signal decreases. In which, the enlargement or shrinking touch signal is composed of the first touch signal and the second touch signal.

According to an embodiment of the invention, the information display module enlarges the preview icon of the object while increasing the amount of the additional information and reduces the preview icon of the object while decreasing the amount of the additional information.

According to an embodiment of the invention, the information display module increases the number of sub icons of the preview icon in the view area corresponding to the object when a distance between a first touch signal and a second touch signal increases and decreases the number of sub icons of the preview icon in the view area corresponding to the object when the distance between the first touch signal and the second touch signal decreases. In which, the enlargement or shrinking touch signal is composed of the first touch signal and the second touch signal.

According to an embodiment of the invention, the information display module enlarges the sub icons of the preview icon in the view area corresponding to the object when a distance between a first touch signal and a second touch signal increases and reduces the sub icons of the preview icon in the view area corresponding to the object when the distance between the first touch signal and the second touch signal decreases. In which, the enlargement or shrinking touch signal is composed of the first touch signal and the second touch signal.

According to an embodiment of the invention, the information display module decreases an overlapped extent between the sub icons of the preview icon in the view area corresponding to the object when a distance between a first touch signal and a second touch signal increases and increases the overlapped extent between the sub icons of the preview icon in the view area corresponding to the object when the distance between the first touch signal and the second touch signal decreases. In which, the enlargement or shrinking touch signal is composed of the first touch signal and the second touch signal.

According to an embodiment of the invention, the additional information includes an object creation time and a custom tag.

According to an embodiment of the invention, each of the objects is a file, a shortcut, or a folder, and when the object is a folder, each of the sub icons of the preview icon is corresponding to a sub object in the folder.

According to an embodiment of the invention, the screen and the touch input/output interface are the same module.

According to an embodiment of the invention, the touch input/output interface is a remote control device, a portable electronic device, a touch pad, or a director.

As described above, the invention allows a user to conveniently view and obtain information of various objects (files, shortcuts, and folders) through an electronic device by operating a touch input/output interface. Thereby, it is made very convenient and intuitional to manage the objects, and meanwhile, it is made very interesting to browse the objects.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic device according to an embodiment of the invention.

FIG. 2 is a flowchart of an information display method according to an embodiment of the invention.

FIG. 3A is a diagram illustrating a pinch gesture according to an embodiment of the invention.

FIG. 3B is a diagram illustrating a expand gesture according to an embodiment of the invention.

FIGS. 4A-4C are diagrams illustrating a file management frame according to an embodiment of the invention.

FIGS. 5A-5C are diagrams illustrating a file management frame according to another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

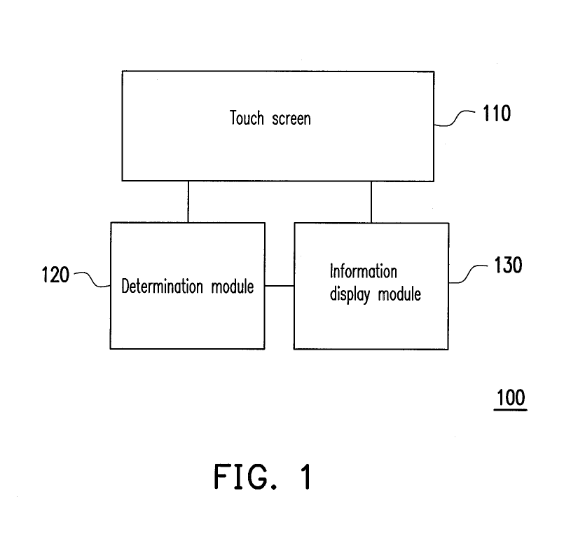

FIG. 1 is a block diagram of an electronic device according to an embodiment of the invention. Referring to FIG. 1, the electronic device 100 includes a touch screen 110, a determination module 120, and an information display module 130. The electronic device 100 may be a desktop computer, a notebook computer, a tablet PC, a cell phone, a personal digital assistant (PDA), or a smart phone. However, the type of the electronic device 100 is not limited herein.

The touch screen 110 may be a capacitive touch screen that supports a multi-touch technique, and which is configured to display various operation frames of the electronic device 100 and detect user's touch operations. Or, the touch screen 110 may also be any touch screen that supports a multi-touch technique, such as a resistive touch screen or an optical touch screen. The type of the touch screen 110 is not limited herein. It should be noted that in the present embodiment, the touch screen 110 is composed of a screen and a touch input/output interface (i.e., the screen and the touch input/output interface are the same module), wherein the screen displays frames, and the touch input/output interface generates signals in response to user's touch operations. However, in other embodiments of the invention, the screen and the touch input/output interface of the electronic device may also be two independent modules. For example, the touch input/output interface may be a remote control, a portable electronic device (with a touch screen), a touch pad, or a director.

The determination module 120 is coupled to the touch screen 110 and is configured to receive touch signals from the touch input/output interface (in the present embodiment, signals from the touch screen 110) and determine whether an enlargement or shrinking touch signal is detected via the touch input/output interface. The information display module 130 is coupled to the touch screen 110 and the determination module 120. The information display module 130 is configured to change the content displayed on the touch screen 110 according to the enlargement or shrinking touch signal.

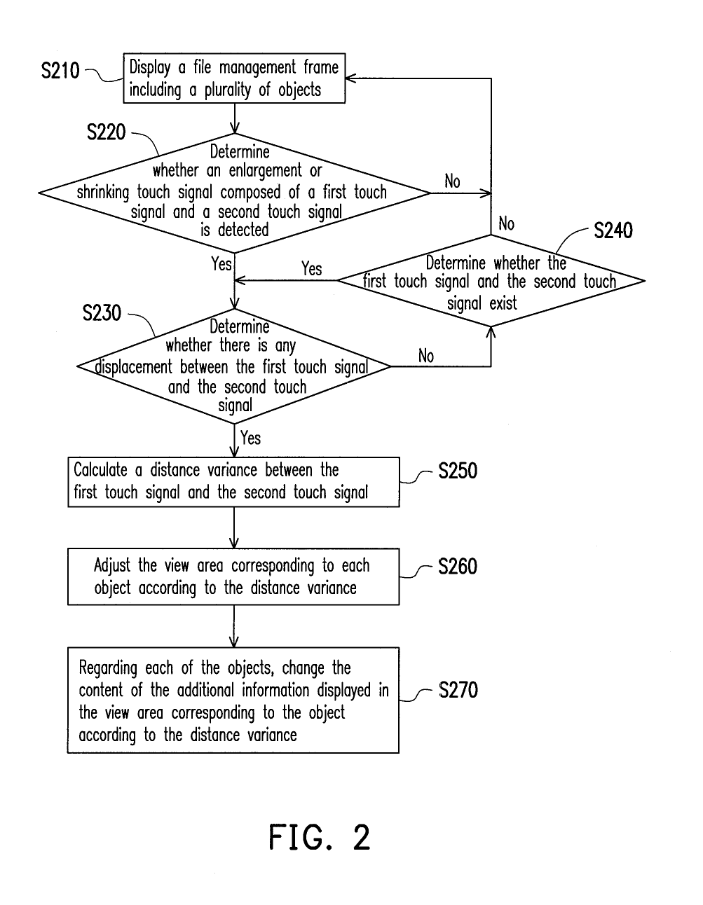

Another embodiment of the invention will be described in order to explain the operation of the electronic device 100 in detail. FIG. 2 is a flowchart of an information display method according to an embodiment of the invention. Please refer to both FIG. 1 and FIG. 2.

First, in step S210, the touch screen 110 displays a file management frame including one or more objects. The file management frame may be a Windows frame or an operation interface of an application program, and each of the objects is a file, a shortcut, or a folder. In the present embodiment, each of the objects is corresponding to a view area within the file management frame, and each of the objects includes additional information and/or a preview icon. Herein the additional information is information other than the title of the file, shortcut, or folder, such as an object creation time or a custom tag. However, the content of the additional information is not limited herein. When an object is a file, the preview icon thereof may be a system preset icon for indicating the file type or a thumbnail of the file content. When an object is a shortcut, the preview icon thereof may be a system preset icon for indicating the target type. When an object is a folder, the preview icon thereof may include one or more sub icons, wherein each of the sub icons is corresponding to a sub object in the folder. Because the touch screen 110 has a limited size, when the file management frame contains too many objects, it may be impossible to display all these objects on the touch screen 110. Below, the area that can be displayed on the touch screen 110 is referred to as a working area of the file management frame, and a user can scroll the working area to view other objects by adjusting a scroll bar of the file management frame.

Then, in step S220, whether an enlargement or shrinking touch signal is detected via the touch screen 110 (i.e. the touch input/output interface) is determined. In the present embodiment, the enlargement or shrinking touch signal is, for example but not limited to, composed of a first touch signal and a second touch signal, wherein the first touch signal and the second touch signal should be touch signals detected within the working area of the file management frame. Namely, this step is to determine whether the user touches any two points within the working area of the file management frame. If the touch screen 110 does not detect the enlargement or shrinking touch signal, the procedure of the information display method returns to step S210.

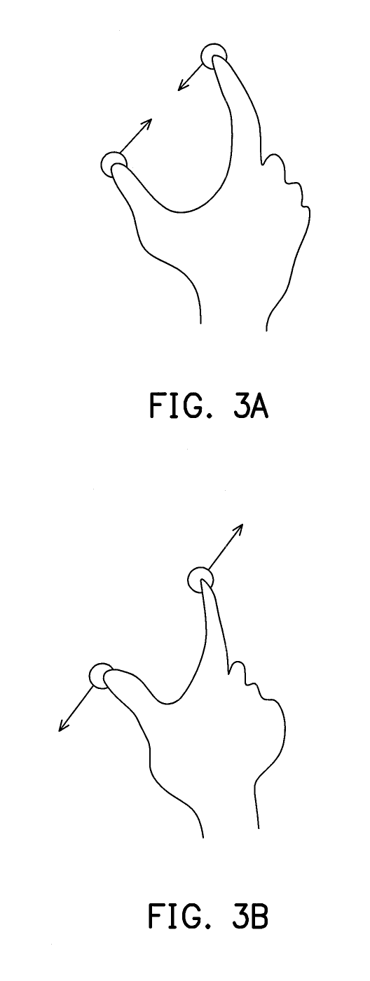

If the touch screen 110 detects the enlargement or shrinking touch signal, the information display module 130 adjusts the view area corresponding to each of the objects according to the enlargement or shrinking touch signal. Regarding each of the objects, the information display module 130 changes a content of the additional information to be displayed according to the enlargement or shrinking touch signal. To be specific, in step S230, the determination module 120 determines whether there is any displacement between the first touch signal and the second touch signal. This is to determine whether the user performs a pinch gesture (as shown in FIG. 3A) or an expand gesture (as shown in FIG. 3B) after touching the touch screen 110 with two fingers.

If there is no displacement between the first touch signal and the second touch signal, in step S240, whether the first touch signal and the second touch signal exist is determined. If at least one of the two signals does not exist, it is determined that the user has moved the input tool (his/her fingers) away from the touch screen 110, and the procedure of the information display method returns to step S210 again. If none of the two signals disappears, the procedure returns to step S230 to determine whether there is any displacement between the first touch signal and the second touch signal.

If there is displacement between the first touch signal and the second touch signal, in step S250, the determination module 120 calculates a distance variance between the first touch signal and the second touch signal. In the present embodiment, the amount of the distance variance is corresponding to different information display level, wherein the information display level refers to the particularity in which the information display module 130 displays the information of an object (file, shortcut, or folder). For example, a greater distance variance is corresponding to a higher information display level, and a smaller distance variance is corresponding to a lower information display level. However, the invention is not limited thereto. Or, several information display levels are preset in the electronic device 100, and these information display levels are distinguished by a plurality of distance variance thresholds. Which information display level the distance variance calculated by the determination module 120 belongs to can be determined by comparing the distance variance with foregoing thresholds.

Next, in step S260, the information display module 130 adjusts the size of the view area corresponding to each object according to the distance variance. To be specific, the information display module 130 simultaneously adjusts the sizes of the view areas corresponding to the objects according to the distance variance. For example, if the distance between the first touch signal and the second touch signal increases, the information display module 130 enlarges the view areas corresponding to the objects simultaneously or one by one. Contrarily, if the distance between the first touch signal and the second touch signal decreases, the information display module 130 reduces the view areas corresponding to the objects simultaneously or one by one. It should be noted that the correspondence between the variation of the distance variance and the adjustment of the view areas described above is only an example but not intended to limit the invention.

Finally, in step S270, regarding each of the objects, the information display module 130 changes the content of the additional information displayed in the view area corresponding to the object according to the distance variance. In the present embodiment, the content of the additional information includes the amount of the additional information and/or one or a combination of the number, size, and arrangement of the sub icons of the preview icon. To be specific, the information display module 130 correspondingly changes the amount of the displayed additional information according to the distance variance. The information display module 130 may also change the content of the preview icon (i.e., change one or a combination of the number, size, and arrangement of the sub icons of the preview icon) according to the distance variance. In addition, the information display module 130 may further change both the amount of the additional information and the content of the preview icon according to the distance variance.

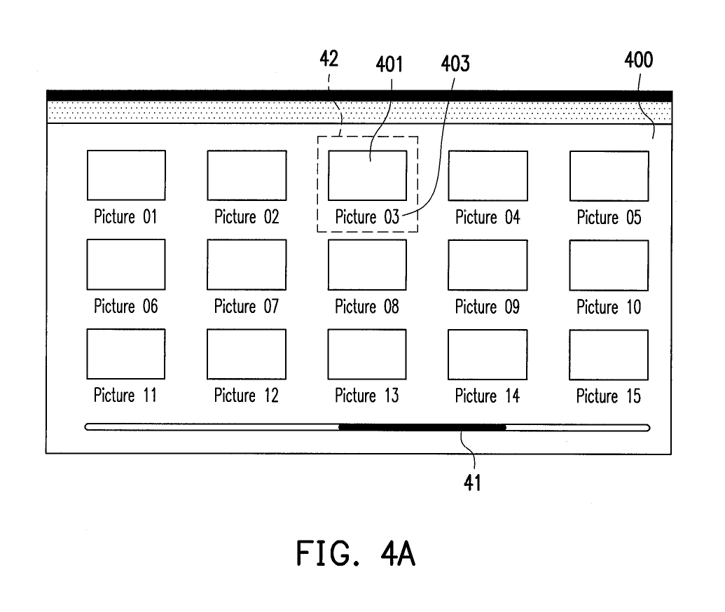

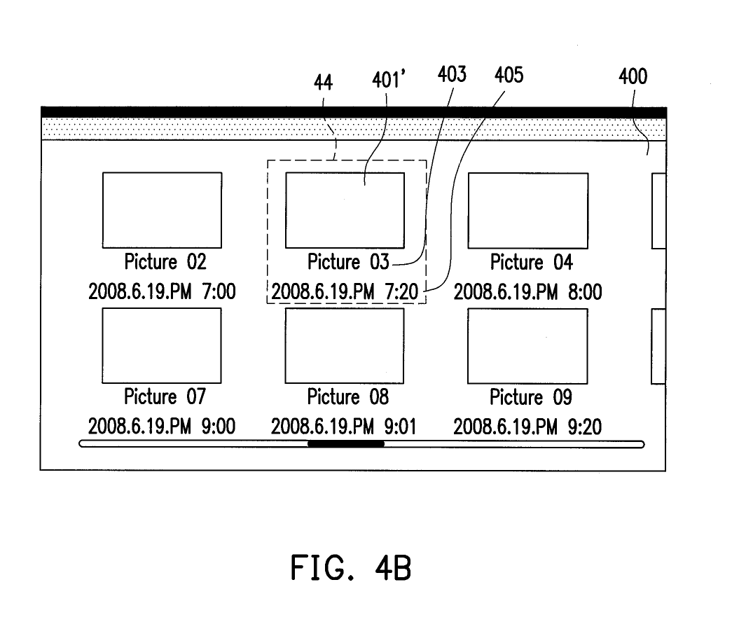

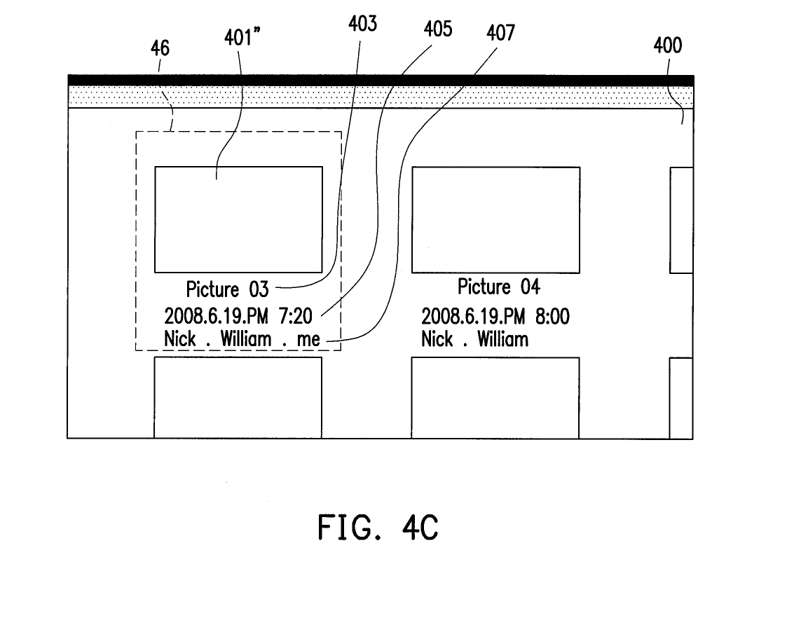

FIGS. 4A-4C are diagrams illustrating a file management frame according to an embodiment of the invention. As shown in FIG. 4A, it is assumed that the file management frame 400 displayed on the touch screen 110 of the electronic device 100 includes a plurality of files, wherein 15 files are displayed within the working area of the file management frame 400, and the user can scroll the working area to view other files of the file management frame 400 by using the scroll bar 41.

In the present embodiment, each file of the file management frame 400 is corresponding to a view area. Taking a view area 42 as an example, the corresponding file has a preview icon 401 and a file name 403 (i.e., the string “picture 03”), and both the preview icon 401 and the file name 403 are displayed within the view area 42. However, it should be noted that even though in the present embodiment, the files in the file management frame 400 are all image files, the invention is not limited thereto, and in other embodiments, the file management frame may also include different types of files.

When the user touches the working area of the file management frame 400 displayed on the touch screen 110 with two fingers and then slides his fingers outwards in opposite directions (i.e., performs an expand gesture), the determination module 120 determines an enlargement or shrinking touch signal composed of a first touch signal and a second touch signal is detected. The distance variance calculated by the determination module 120 indicates that the distance between the first touch signal and the second touch signal increases. In this case, the information display module 130 simultaneously enlarges the view areas corresponding to the files and increases the amount of displayed additional information in the view area corresponding to each file. Besides increasing the amount of the displayed additional information, in the present embodiment, the information display module 130 also enlarges the preview icon of each file.

FIG. 4B is a diagram of the file management frame 400 after the user performs an expand gesture. Referring to both FIG. 4A and FIG. 4B, the view area 44 corresponding to the same file as the view area 42 in FIG. 4A is enlarged by the information display module 130, and besides the enlarged preview icon 401′ and the file name 403, an additional information of a file creation time 405 (i.e., the string “2008.6.19. PM 7:20”) is further displayed in the view area 44.

If the user touches the working area of the file management frame 400 with two fingers and then performs an expand gesture again, the determination module 120 determines another enlargement or shrinking touch signal composed of a first touch signal and a second touch signal is detected. The distance variance calculated by the determination module 120 indicates that the distance between the first touch signal and the second touch signal increases. In this case, the information display module 130 further increases the amount of the displayed additional information and enlarges the preview icons. As shown in FIG. 4C, besides the further enlarged preview icon 401″, the file name 403, and the file creation time 405, an additional information of a custom tag 407 (i.e., the string “Nick. William. me”) is further displayed in the view area 46 corresponding to the same file as the view area 44 in FIG. 4B.

Meanwhile, it can be observed by comparing FIG. 4A to FIG. 4C that the electronic device 100 presents more detailed additional information of the files every time when the user performs an expand gesture.

Similarly, in the present embodiment, if the user touches the working area of the file management frame 400 displayed on the touch screen 110 with two fingers and then slides his fingers inwards (i.e., performs a pinch gesture), the distance variance calculated by the determination module 120 indicates that the distance between the first touch signal and the second touch signal decreases. In this case, the information display module 130 reduces the view area corresponding to each object, decreases the amount of the additional information displayed in each view area, and reduces the preview icon of each object.

In the embodiment described above, the user can trigger the electronic device 100 to display more additional information of each file by performing expand gestures on the touch screen 110. When aforementioned additional information is not needed, the user can hide the additional information of each file by performing a pinch gesture on the touch screen 110. Thereby, it is made very convenient to browse the files.

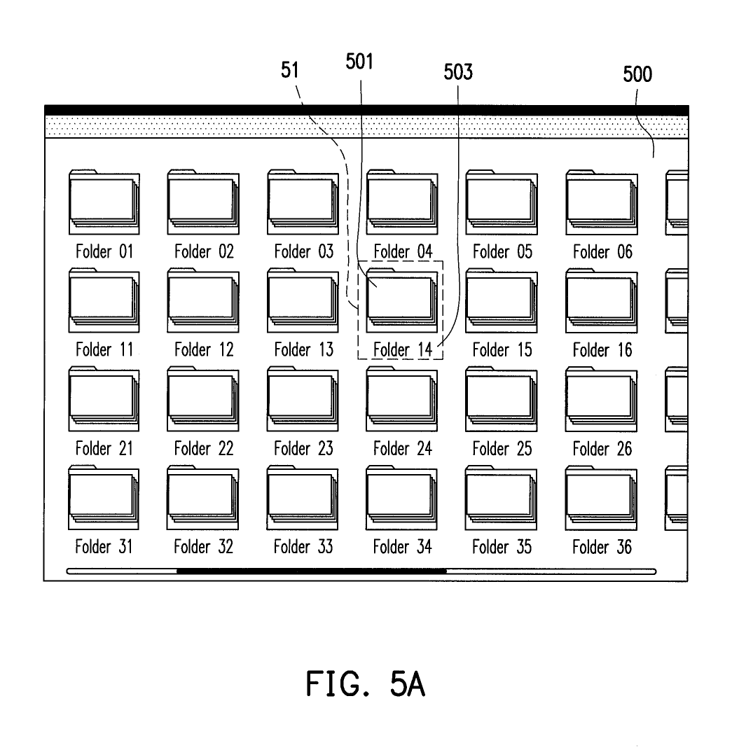

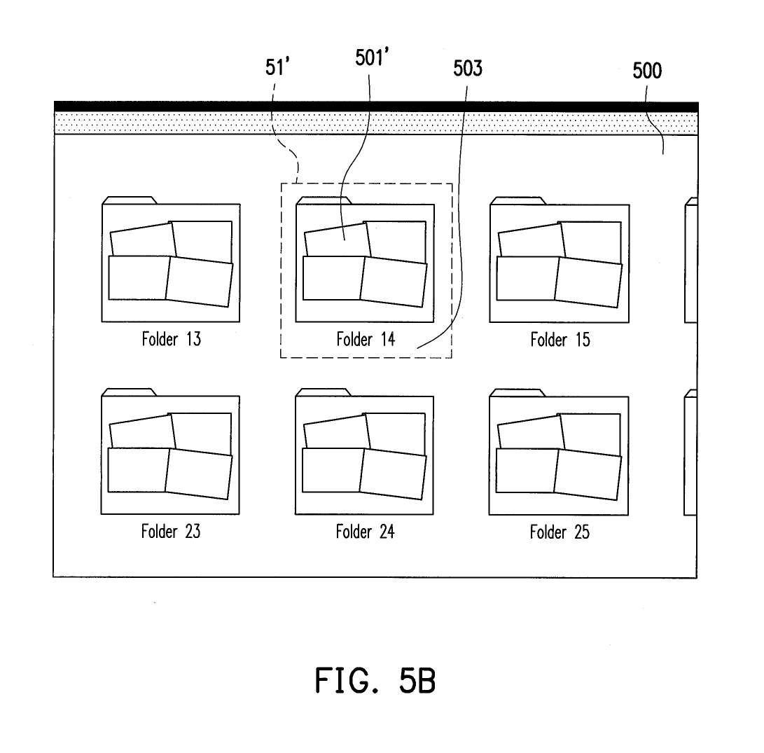

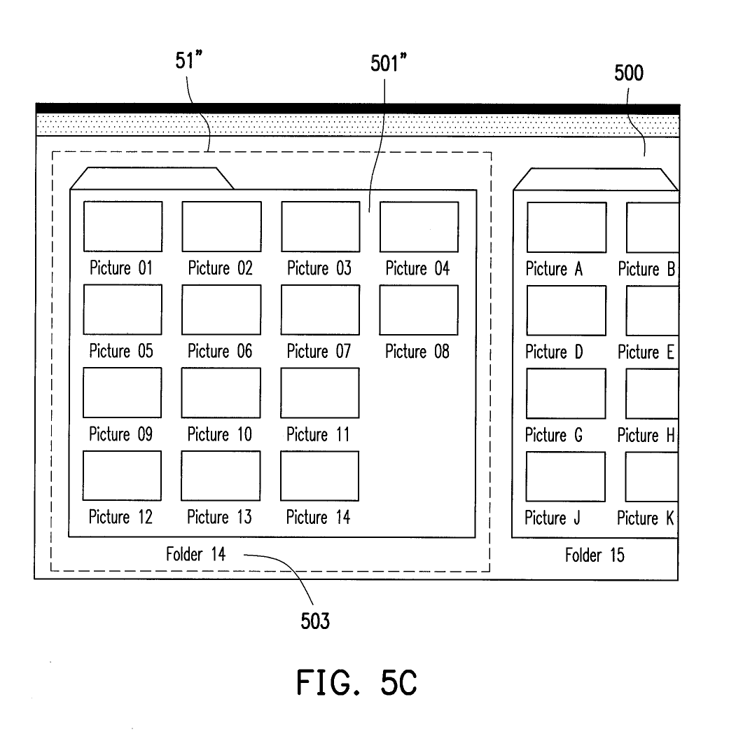

FIGS. 5A-5C are diagrams illustrating a file management frame according to another embodiment of the invention. Referring to FIG. 5A, in the present embodiment, the file management frame 500 displayed by the touch screen 110 of the electronic device 100 includes a plurality of folders, wherein each of the folders is corresponding to a view area within the file management frame 500. For example, a preview icon 501 and a folder name 503 (i.e., the string “folder 14”) of the corresponding folder are displayed in the view area 51. Herein the preview icon 501 includes 4 sub icons that are stacked together, and each of the sub icons is corresponding to a sub object in the folder. Each sub object may be a file, a shortcut, or a folder. However, the type of each sub object is not limited herein.

In the present embodiment, when the user touches the working area of the file management frame 500 displayed on the touch screen 110 with two fingers and then slides his fingers outwards in two opposite directions (i.e., performs an expand gesture), the determination module 120 determines an enlargement or shrinking touch signal composed of a first touch signal and a second touch signal is detected. The distance variance calculated by the determination module 120 indicates that the distance between the first touch signal and the second touch signal increases. In this case, the information display module 130 simultaneously enlarges the view areas corresponding to the folders and decreases an overlapped extent between the sub icons of the preview icon of each folder.

The file management frame 500 is as shown in FIG. 5B through the operations of the determination module 120 and the information display module 130. Referring to both FIG. 5A and FIG. 5B, taking the view area 51′ as an example, the view area 51′ and the view area 51 are corresponding to the same folder, but the view area 51′ is enlarged by the information display module 130. Besides, it can be observed by comparing the preview icon 501 and the preview icon 501′ that after the user performs the expand gesture, the overlapped extent between the 4 sub icons of the preview icon 501′ is decreased to be lower than that between the 4 sub icons of the preview icon 501. In other words, the sub icons in the preview icon 501′ are loosely arranged.

If the user touches the working area of the file management frame 500 with two fingers and then performs an expand gesture again, the determination module 120 determines another enlargement or shrinking touch signal composed of a first touch signal and a second touch signal is detected. The distance variance calculated by the determination module 120 indicates that the distance between the first touch signal and the second touch signal further increases. In this case, the information display module 130 further enlarges the view area corresponding to each folder. In the present embodiment, if the information display module 130 determines that the view area corresponding to each folder already exceeds a predetermined range (for example, is close to or over half of the display area of the touch screen 110), besides decreasing the overlapped extent between the sub icons in the preview icon of each folder, the information display module 130 further increases the number of sub icons in the preview icon. Referring to both FIG. 5B and FIG. 5C, regarding the view area 51″ and the view area 51′ that are corresponding to the same folder, not only the view area 51″ is enlarged, but the number (i.e., 14) of sub icons in the preview icon 501″ is greater than the number (i.e., 4) of sub icons in the preview icon 501′. Additionally, in the preview icon 501″, the sub icons do not overlap each other, and the name of the corresponding file is further displayed below each sub icon.

The variation of the file management frame 500 after the user performs an expand gesture twice can be observed from FIG. 5A to FIG. 5C. Similarly, when the user touches the working area of the file management frame 500 with two fingers and then slides his fingers inwards (i.e., performs a pinch gesture), the distance between the first touch signal and the second touch signal decreases. In this case, besides simultaneously reducing the view areas corresponding to the folders, the information display module 130 further increases the overlapped extent between the sub icons in the preview icon of each object in the view area corresponding to the object. When the information display module 130 determines that the size of the view area corresponding to each folder is already smaller than a predetermined value, the information display module 130 decreases the number of sub icons in each preview icon.

In the embodiment described above, the information display module 130 adjusts the number and/or arrangement of sub icons in the preview icon of each folder according to a distance variance between a first touch signal and a second touch signal. In other embodiments, when the distance between the first touch signal and the second touch signal increases, the information display module 130 enlarges each sub icon of the preview icon in the view area corresponding to each folder. When the distance between the first touch signal and the second touch signal decreases, the information display module 130 reduces each sub icon of the preview icon in the view area corresponding to each folder. Namely, the information display module 130 may only adjust the number of sub icons in the preview icon, only adjust the size of each sub icon in the preview icon, or only adjust the arrangement of sub icons in the preview icon according to the distance variance, or the information display module 130 may also adjust any two or all three of the number, size, and arrangement of the sub icons in the preview icon at the same time.

In a conventional file management environment, only the size of the preview icon of the entire folder but not the content thereof is changed when the user enlarges or reduces the frame. However, in the embodiments of the invention described above, once a pinch or expand gesture of the user is detected on the touch screen 110, the electronic device 100 correspondingly changes one or a combination of the number of sub objects to be displayed in each folder, the sizes of sub icons corresponding to the sub objects, and the arrangement of the sub icons, so as to allow the user to obtain more information while browsing the folders.

Even though foregoing embodiments are described by assuming that a file management frame includes a plurality of objects of the same type, the invention is not limited thereto. In other words, a file management frame may also include objects of different types, and in this case, a user can still change the amount of displayed additional information of a file and/or the number, size, or arrangement of sub icons in the corresponding preview icon through any gesture (for example, pinch or expand gesture) that can produce two touch signals.

It should be mentioned that the information display method described in foregoing embodiments may also be implemented as program instruction codes and stored in a computer program product that can be read by an electronic device. Foregoing steps of the information display method can be accomplished by loading the program instruction codes into the electronic device.

In summary, the invention provides an electronic device and an information display method thereof, wherein if a user performs a pinch or expand gesture on the touch screen after a file management frame including a plurality of objects is displayed, the content of additional information of each of the objects can be correspondingly changed. For example, the amount of the additional information and/or one or a combination of the number, size, and arrangement of sub icons in the preview icon is changed. Accordingly, a user can conveniently and intuitionally obtain more information of the objects in an electronic device while browsing the objects and it is made very interesting for the user to browse the objects.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An information display method, adaptable to an electronic device configured to receive signals from a touch input/output interface and having a screen, wherein the screen displays a file management frame comprising a plurality of objects, each of the objects is corresponding to a view area within the file management frame, and each of the objects comprises an additional information and/or a preview icon, the information display method comprising:
detecting an enlargement or shrinking touch signal via the touch input/output interface;
adjusting the view area corresponding to each of the objects according to the enlargement or shrinking touch signal; and
regarding each of the objects, changing a content of the additional information displayed in the view area corresponding to the object according to the enlargement or shrinking touch signal.

2. The information display method according to claim 1, wherein the step of adjusting the view area corresponding to each of the objects according to the enlargement or shrinking touch signal comprises:
simultaneously adjusting the view areas corresponding to the objects according to the enlargement or shrinking touch signal.

3. The information display method according to claim 2, wherein the step of simultaneously adjusting the view areas corresponding to the objects according to the enlargement or shrinking touch signal comprises:
when a distance between a first touch signal and a second touch signal increases, enlarging the view areas corresponding to the objects, wherein the enlargement or shrinking touch signal is composed of the first touch signal and the second touch signal; and
when the distance between the first touch signal and the second touch signal decreases, reducing the view areas corresponding to the objects.

4. The information display method according to claim 1, wherein the step of regarding each of the objects, changing the content of the additional information displayed in the view area corresponding to the object according to the enlargement or shrinking touch signal comprises:
correspondingly changing the content of the displayed additional information according to the enlargement or shrinking touch signal, wherein the content comprises an amount of the additional information and/or one or a combination of a number, a size, and an arrangement of a plurality of sub icons of the preview icon.

5. The information display method according to claim 4, wherein the step of correspondingly changing the content of the displayed additional information according to the enlargement or shrinking touch signal comprises:
when a distance between the a first touch signal and a second touch signal increases, increasing the amount of the displayed additional information in the view area corresponding to the object, wherein the enlargement or shrinking touch signal is composed of the first touch signal and the second touch signal; and
when the distance between the first touch signal and the second touch signal decreases, decreasing the amount of the displayed additional information in the view area corresponding to the object.

6. The information display method according to claim 5 further comprising:
enlarging the preview icon of the object while increasing the amount of the displayed additional information; and
reducing the preview icon of the object while decreasing the amount of the displayed additional information.

7. The information display method according to claim 4, wherein the step of correspondingly changing the content of the displayed additional information according to the enlargement or shrinking touch signal comprises:
when a distance between a first touch signal and a second touch signal increases, increasing the number of the sub icons of the preview icon in the view area corresponding to the object, wherein the enlargement or shrinking touch signal is composed of the first touch signal and the second touch signal; and
when the distance between the first touch signal and the second touch signal decreases, decreasing the number of the sub icons of the preview icon in the view area corresponding to the object.

8. The information display method according to claim 4, wherein the step of correspondingly changing the content of the displayed additional information according to the enlargement or shrinking touch signal comprises:
when a distance between a first touch signal and a second touch signal increases, enlarging the sub icons of the preview icon in the view area corresponding to the object, wherein the enlargement or shrinking touch signal is composed of the first touch signal and the second touch signal; and
when the distance between the first touch signal and the second touch signal decreases, reducing the sub icons of the preview icon in the view area corresponding to the object.

9. The information display method according to claim 4, wherein the step of correspondingly changing the content of the displayed additional information according to the enlargement or shrinking touch signal comprises:
when a distance between a first touch signal and a second touch signal increases, decreasing an overlapped extent between the sub icons of the preview icon in the view area corresponding to the object, wherein the enlargement or shrinking touch signal is composed of the first touch signal and the second touch signal; and
when the distance between the first touch signal and the second touch signal decreases, increasing the overlapped extent between the sub icons of the preview icon in the view area corresponding to the object.

10. The information display method according to claim 1, wherein the additional information comprises an object creation time and a custom tag.

11. The information display method according to claim 1, wherein each of the objects is one of a file, a shortcut, and a folder, and when the object is the folder, each of the sub icons of the preview icon is corresponding to a sub object in the folder.

12. The information display method according to claim 1, wherein the touch input/output interface is a remote control device, a portable electronic device, a touch pad, or a director.

13. An electronic device, comprising:
a screen, for displaying a file management frame comprising a plurality of objects, and for displaying an additional information and/or a preview icon of each of the objects in a view area within the file management frame;
a determination module, for receiving signals from a touch input/output interface and determining whether an enlargement or shrinking touch signal is detected via the touch input/output interface; and
an information display module, coupled to the screen and the determination module, for adjusting the view area corresponding to each of the objects according to the enlargement or shrinking touch signal, and regarding each of the objects, changing a content of the additional information to be displayed according to the enlargement or shrinking touch signal and controlling the screen to display the additional information and the preview icon in the view area corresponding to the object.

14. The electronic device according to claim 13, wherein the information display module simultaneously adjusts the view areas corresponding to the objects according to the enlargement or shrinking touch signal.

15. The electronic device according to claim 14, wherein when a distance between a first touch signal and a second touch signal increases, the information display module enlarges the view areas corresponding to the objects, and when the distance between the first touch signal and the second touch signal decreases, the information display module reduces the view areas corresponding to the objects, wherein the enlargement or shrinking touch signal is composed of the first touch signal and the second touch signal.

16. The electronic device according to claim 13, wherein regarding each of the objects, the information display module correspondingly changes the content of the displayed additional information according to the enlargement or shrinking touch signal, wherein the content comprises a amount of the additional information and/or one or a combination of a number, a size, and an arrangement of a plurality of sub icons of the preview icon.

17. The electronic device according to claim 16, wherein when a distance between a first touch signal and a second touch signal increases, the information display module increases the amount of the displayed additional information in the view area corresponding to the object, and when the distance between the first touch signal and the second touch signal decreases, the information display module decreases the amount of the displayed additional information in the view area corresponding to the object, wherein the enlargement or shrinking touch signal is composed of the first touch signal and the second touch signal.

18. The electronic device according to claim 17, wherein the information display module enlarges the preview icon of the object while increasing the amount of the displayed additional information and reduces the preview icon of the object while decreasing the amount of the displayed additional information.

19. The electronic device according to claim 16, wherein when a distance between a first touch signal and a second touch signal increases, the information display module increases the number of the sub icons of the preview icon in the view area corresponding to the object, and when the distance between the first touch signal and the second touch signal decreases, the information display module decreases the number of the sub icons of the preview icon in the view area corresponding to the object, wherein the enlargement or shrinking touch signal is composed of the first touch signal and the second touch signal.

20. The electronic device according to claim 16, wherein when a distance between a first touch signal and a second touch signal increases, the information display module enlarges the sub icons of the preview icon in the view area corresponding to the object, and when the distance between the first touch signal and the second touch signal decreases, the information display module reduces the sub icons of the preview icon in the view area corresponding to the object, wherein the enlargement or shrinking touch signal is composed of the first touch signal and the second touch signal.

21. The electronic device according to claim 16, wherein when a distance between a first touch signal and a second touch signal increases, the information display module decreases an overlapped extent between the sub icons of the preview icon in the view area corresponding to the object, and when the distance between the first touch signal and the second touch signal decreases, the information display module increases the overlapped extent between the sub icons of the preview icon in the view area corresponding to the object, wherein the enlargement or shrinking touch signal is composed of the first touch signal and the second touch signal.

22. The electronic device according to claim 13, wherein the additional information comprises an object creation time and a custom tag.

23. The electronic device according to claim 13, wherein each of the objects is one of a file, a shortcut, and a folder, and when the object is the folder, each of the sub icons of the preview icon is corresponding to a sub object in the folder.

24. The electronic device according to claim 13, wherein the screen and the touch input/output interface are a same module.

25. The electronic device according to claim 13, wherein the touch input/output interface is a remote control device, a portable electronic device, a touch pad, or a director.
